(19) United States
(12) Patent Application Publication
(10) Pub. No.: US 2017/0258091 A1
(43) Pub. Date: Sep. 14, 2017

(54) PROCESS FOR CONTROLLING BACTERIAL, FUNGAL AND VIRAL DISEASES IN CROPS OR PLANTS WITH SODIUM CHLORITE SOLUTIONS

(71) Applicants: Javier Jesus Burgos Bracho, Estado Carabobo (VE); Domingo Antonio Serpa Gil, Estado Lara (VE)

(72) Inventors: Javier Jesus Burgos Bracho, Estado Carabobo (VE); Domingo Antonio Serpa Gil, Estado Lara (VE)

(73) Assignee: AGRO SOLUCIONES 21, LLC, Miami, FL (US)

(21) Appl. No.: 15/065,150

(22) Filed: Mar. 9, 2016

(51) Int. Cl. A01N 59/00; A01N 25/02

(52) U.S. Cl. CPC A01N 59/00; A01N 25/02

(57) ABSTRACT

A technique for eliminating bacterial, fungal, and viral diseases in growing plants involves the generation of chlorine dioxide gas by dissolution of sodium chlorite with an activating acid in an aqueous solution. Foliar application of the dissolved gas solution to soil or plants growing in fields follows. Preferred acid solutions contain phosphoric acid (H₃PO₄), Citric Acid (C₆H₈O₇) or a mix of both.

### BACKGROUND OF THE INVENTION

1. Field of the Invention

The present invention relates to the treatment and prevention of bacterial, fungal and viral diseases in growing plants. More particularly, the present invention relates to the treatment and prevention of bacterial, fungal, and viral diseases by application of an acid-activated sodium chlorite solution (NaClO₂) to growing crops.

2. Description of the Related Art

Plant diseases caused by bacterial, fungal, and viral organisms are responsible for loss of yields of harvested crops. Despite significant scientific advances in fungicidal and bacterial development in the last 50 years, many bacterial, fungal, and viral diseases in such plants remain partially or completely uncontrolled.

The National Plant Disease Recovery System (NPDRS) is called for in Homeland Security Presidential Directive Number 9 (HSPD-9), issued in February 2004. The purpose of the NPDRS is to ensure that the tools, infrastructure, communication networks, and capacity required to mitigate the impact of high consequence plant disease outbreaks are such that a reasonable level of crop production is maintained in the U.S.

For example, the bacteria that causes the Black Sigatoka disease in bananas (caused by the fungus Mycosphaerella fijiensis (Morelet)), which is also known as black leaf streak, causes significant reductions in leaf area, yield losses of 50% or more, and premature ripening, a serious defect in exported fruit. It is more damaging and difficult to control than the related Yellow Sigatoka disease and has a wider host range that includes the plantains, dessert, and ABB cultivar cooking bananas that are usually not affected by Yellow Sigatoka.

The bacteria that causes Huanglongbing (Candidatus Liberibacter spp), more commonly known as citrus greening, is a disease that was first detected in the United States in August, 2005 in Miami-Dade County, Florida. This disease has seriously impacted citrus production all over the globe. Citrus greening is a major threat to the U.S. citrus industry. Other than tree removal there is no effective way to control the disease once the plant has been infected. Since being discovered in 2005 this disease has spread to all 32 of the State of Florida's citrus growing counties. Citrus greening has also been found in Georgia, South Carolina, Louisiana, Texas, and California. Florida's citrus industry has already lost $4.5 billion and 85,000 jobs.

It is postulated that fungal diseases are difficult to eliminate and even control; this is due to the steep exponential growth of fungus generally through spore dispersion and is also due to the hard spore coverings protecting the spores from various environmental conditions and a number of fungicides that would otherwise kill or deactivate the spores. Additionally, the mode of growth of fungal diseases in plants contributes to prevention and eradication difficulties. For many plant fungal diseases, such as rust and blight, the fungal spores make the initial contact with foliage surfaces. The actual disease occurs when these surface spores germinate, undergoing morphological changes and developing tubes which enter the plant through the stomata of the foliage surfaces, infecting the intracellular areas. These infections then spread throughout leaf, stem, and flower tissues, invading the plant throughout.

Thus, with respect to plants, for example, the fungus not only grows on the foliar surfaces, but also spreads systemically. The portions of the fungal population not exposed to the surface of the plant are very difficult to eradicate. Intuitively, one might not expect a surface direct treatment to be highly effective against such fungal populations.

One antimicrobial agent that has long been used as a surface decontaminant is sodium chlorite. Sodium chlorite is a salt and when mixed in water to form a solution, and then subjected to an acid, sodium chlorite will convert to chlorine dioxide. This activation technique is often utilized because chlorine dioxide gas can be explosive; thus shipping of containers of chlorine dioxide gas is not preferred. The acid used for activation purposes can be either a mono- or multi-valent acid and be either inorganic or organic. The maximum theoretical conversion of sodium chlorite to chlorine dioxide following acid activation is approximately 80%. In the presence of a monovalent acid, such as hydrochloric acid, the following reaction is expected to occur:

5NaClO₂+4HCl [symbol] 4ClO_{2(g)}+5NaCl+2H₂O

with 5 moles of sodium chlorite required to generate 4 moles of chlorine dioxide. In the presence of a trivalent acid, such as phosphoric acid, the following reaction is expected to occur:

6NaClO₂+2H₃PO₄-->6ClO₂+2Na₃PO₄+3H₂O

with 6 moles of sodium chlorite required to generate 6 moles of chlorine dioxide.

Hard surface sanitation is a known use for chlorine dioxide. Hard surfaces in public places (e.g., restaurant countertops) is one use for chlorine dioxide. Other uses include surface and water treatment sanitation in animal confinement areas such as barns, poultry houses, boarding kennels and the like.

Aside from surface sanitation use on restaurant countertops and the like in public facilities, the Environmental Protection Agency has approved the use of sodium chlorite for surface application to certain harvested vegetables and to certain seeds prior to planting. For example, sodium chlorite was approved in 1995 as a seed-soak treatment prior to planting and growing brassica, leafy vegetables and radishes. More recently, the EPA approved the use of chlorine dioxide on stored potatoes by acid activation of sodium chlorite to produce chlorine dioxide. Supplemental labeling of Purogene® for treatment of stored potatoes lists application rates of 200 and 400 parts per million (ppm) of sodium chlorite to stored potatoes to control late blight (Phytophthora infestans).

The U.S. Food and Drug Administration has also approved the uses of acidified sodium chlorite solutions as an antimicrobial agent in water to treat harvested fruits and vegetables. The approval is limited to application as dip or direct spray at concentrations of between 500 and 1,200 ppm when used with an approved acid at a level sufficient enough to achieve a solution pH of 2.3 to 2.9.

Continuous chlorine dioxide gas treatments on fresh supermarket purchased strawberries have also been tested to determine the efficacy in reducing counts of E. coli O0157:H7 and Listeria monocytogenes. The strawberries were treated with chlorine dioxide produced by a generator using chlorine gas.

There remains a need for a microbicide which prevents or controls the spread of diseases in growing crops. The mode of action of such a microbicide should be such that bacterial, fungal, or viral resistance is not expected. Also, limitations on the number of applications or the timing of applications to a single crop may be minimized so that if multiple microbiological infestations or late season infestations occur, use of an effective microbicide is not precluded. Finally, a microbicide which doesn't require substantial amounts for effective treatment is preferred, for both economy of application and also risk of health hazards to workers which may increase with increases in concentration of chemical applications.

### SUMMARY OF THE INVENTION

The present invention relates to a system and method of reducing bacterial, fungal, and viral diseases in growing plants. The system and method involve the generation of chlorine dioxide gas by dissolution of sodium chlorite with an activating acid in an aqueous solution and by foliar application of the dissolved gas to plants growing in fields. One known acid solution contains phosphoric acid. In one embodiment of the system and method of the present invention, the application rate of the chlorine dioxide effective ingredient of the present invention to control diseases in plants is up to about 324 ml of the prepared sodium chlorite and phosphoric acid solutions (each) per acre. This equals to up to about 800 ml (cc) each of the prepared sodium chlorite (1.5 to 2.5%) and phosphoric acid (1.0 to 3.0%) solutions per hectare. The amount of active ingredients applied to the fields is between 0.0055 and 0.011 pounds per acre or 0.0136 to 0.0272 pound per hectare.

The treatment method of the present invention is not expected to promote microbiogical resistance, as chlorine dioxide's mode of action involving oxidation, which occurs at multiple sites, is not limited to particularized positions on one or more target enzymes.

In some embodiments, the method comprises spray treatment. In some embodiments, spray treatment comprises any conventional atomization method used to generate spray droplets, including hydraulic nozzles and rotating disk atomizers, for application to a foliar surface of the plant.

In some embodiments, the method comprises soil treatment. In some embodiments, soil treatment comprises any conventional technique for introducing the compounds or compositions described and disclosed herein into the soil, for example by drizzling, soil spraying, soil injection, coated granules and the like.

In some embodiments, the method comprises application of the compounds or compositions described and disclosed herein to the surface or locus of the plant.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 illustrates a schematic chart of the application process.

FIG. 2 illustrates a schematic chart of the creation of the product of the invention.

### DETAILED DESCRIPTION OF THE INVENTION

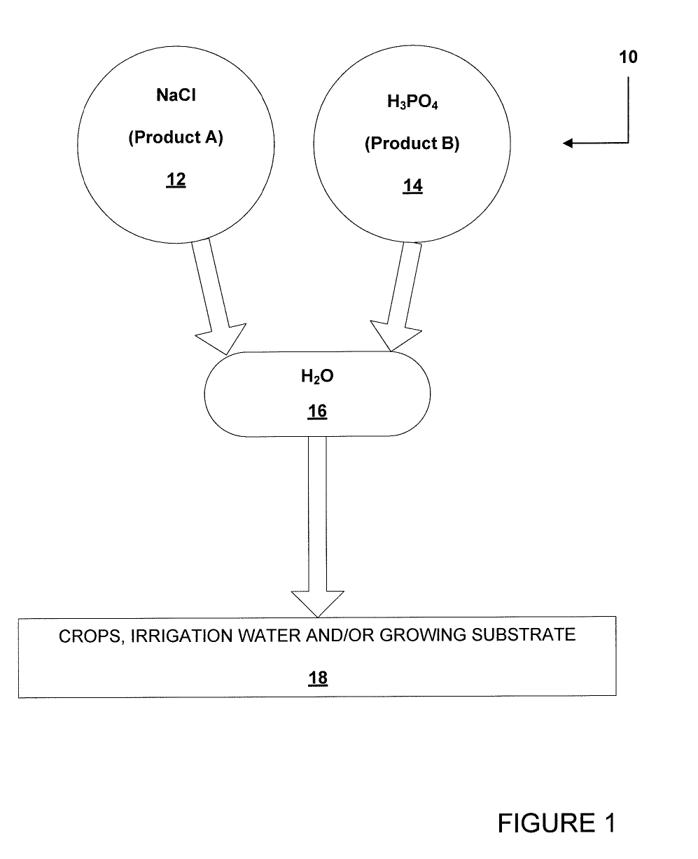

The present invention relates to a method of reducing bacterial, fungal, and viral diseases in growing plants. The method, shown generally as element 10 in FIG. 1 involves the generation of chlorine dioxide gas by dissolution of sodium chlorite with an activating acid in an aqueous solution and by foliar application of the dissolved gas to plants growing in fields. Efficacious acid solutions may be monovalent or multivalent acids. One efficacious multivalent acid solution contains phosphoric acid.

### Example I

An aqueous solution containing approximately 0.63 pounds of NaCl per gallon of water is applied to a spray tank partially filled with approximately 800 liters (approximately 211 gallons) of water. An equal amount by weight of approximately 1% concentration phosphoric acid is added to the same spray tank. Citric, sulfuric, chlorhidric (or hydrochloric), sulfamic, oxalic or acetic acids may be added instead of phosphoric acid.

In one embodiment, in order to achieve a 0.05 pound of active ingredient per acre application rate, a predetermined amount of the sodium chlorite solution was added to a spray tank partially filled with water. For each fluid ounce of sodium chlorite solution added to the tank, 1 fluid ounce of 1% concentration phosphoric acid was added, and the tank was then topped off with water. Foliar spray application to the banana field then followed promptly. Alternatively, a second application may be made as necessary.

Bananas treated with the Example I treatment presented a reduction of 77% in the evolutive stage of Sigatoka Nigra and a 100% reduction of presence of the disease in the fourth leaf of the acreage three weeks after a single application. Additionally, bacterial (Erwinia sp.) infections were controlled in the process. Only one application was required during the growing season. The plants treated with the Example I treatment were observed to have less spotting and to be 30 to 40% healthier and greener looking than treated with traditional fungicide treatment. Treated plants were also healthier and greener than an untreated control group.

### Example II

A field fungicide test was conducted on acreage, on bell peppers presenting severe incidence of fungal anthracnose and viral ringspot.

The sodium chlorite solution to which the diluted phosphoric acid activator was added in accordance with Example I was applied to selected acreage at a rate of 0.05 lbs. sodium chlorite per acre. The plants were treated twice. The second application was made five (5) days after the first application. Additional applications made once per month may be made as an alternative embodiment of the present invention.

Symptoms on bell peppers treated twice in this Example II disappeared after 4 days, leaving only a discolored spot where the infection attacked the leaves. Heavily affected necrotic leaves dropped off, less affected leaves recovered and crop production did not suffer.

The sodium chlorite and the acid solution are used on the growing crops as follows and shown in FIG. 1.

Sodium chlorite (Product A) 12 is a precursor chemical for the production of chlorine dioxide, which is an active compound that destroys and controls fungicidal, bactericidal and viral growth in growing crops.

An acid such as phosphoric acid (Product B) 14 is an activator that, when mixed in approximately equal proportions with the sodium chlorite, generates a chlorine dioxide solution at an efficacious concentration. Citric, sulfuric, chlorhidric (or hydrochloric), sulfamic, oxalic or acetic acids may be added instead of phosphoric acid.

Both Products A 12 and B 14 are added to a quantity of water 16 to be applied on the crops themselves 16, irrigation water, soil and/or growing substrate for the crops by the appropriate method. Methods that may be selected by a user include spray, irrigation, immersion, or other methods known in the art, so that the applied solution is prepared correctly and applied in the correct manner and quantity in a secure manner.

The microbicidal effect of the solution created is almost immediate (approximately less than 30 minutes).

All crops may be treated, in all stages of growth, from seed to harvest, also the water used to irrigate them and the substrate they grow in may be treated with the solution.

In one embodiment of the process of the present invention, up to 324 ml (cc) of the prepared sodium chlorite and phosphoric acid solutions (each) are used per acre of growing crops. This equals to up to 800 ml (cc) each of the prepared sodium chlorite (1.5 to 2.5%) and phosphoric acid (1.0 to 3.0%) solutions per hectare. Active ingredient applied to the fields is between 0.0055 and 0.011 pounds per acre or approximately 0.0136 to 0.0272 pound per hectare.

The Products A+B may be combined just before application to the crops or other use as described herein. Application may be done about four (4) hours after mixture preparation so that the mixture is active during application. The products may be mixed in a mixing tank and then brought to an application area, or they may be mixed and then the product is brought to the application area.

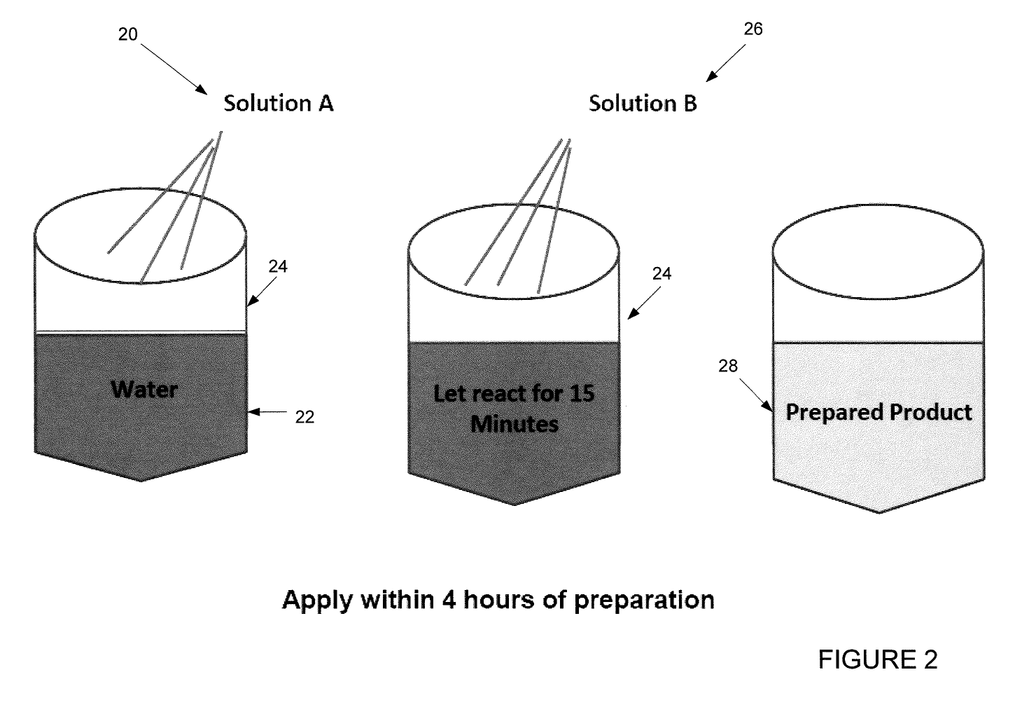

One method of mixing is illustrated in FIG. 2. As shown, Solution A including NaCl 20 is combined with water 22. In a storage tank 24 in the proportions discussed above. To this mixture, Solution B 26 containing acid as described above is added in the storage tank 24, and after letting Solution B 26 react in the storage tank 24 for approximately 15 minutes, the prepared product 28 is ready for application. Application may be made within about four (4) hours of preparation of the final product. Other methods of application and creation are known in the art to achieve the resulting concentrations of the active ingredients in the prepared product are also contemplated.

It will be appreciated by persons skilled in the art that the present invention is not limited to what has been particularly shown and described herein above. In addition, unless mention was made above to the contrary, it should be noted that the accompanying drawings are not to scale. A variety of modifications and variations are possible in light of the above teachings without departing from the scope and spirit of the invention.

1. A method for the elimination of at least one of bacteria, fungi, virus, and mold in growing plants and the stimulation of plant health, vitality, and productivity comprising the step of: applying a chlorine dioxide solution containing phosphorus to at least one of growing plants, a plant substrate, irrigation water and soil.

2. The method of claim 1, wherein the chlorine dioxide solution is formed by the step of mixing a sodium chlorite solution with an acid in solution.

3. The method of claim 2, wherein the acid in solution is a phosphonic acid (H₃PO₃) or other phosphorous based acids or acid solutions containing phosphorus.

4. The method of claim 2, wherein the step of mixing the sodium chlorite solution with the multivalent acid in solution is taken within approximately 30 minutes of the step of applying the chlorine dioxide solution to at least one of growing plants, a plant substrate, irrigation water and soil.

5. The method of claim 2, wherein the step of mixing the sodium chlorite solution with the phosphonic acid (h3PO3) or other phosphorous based acids or acid solutions containing phosphorus is taken approximately within between 30 minutes and four hours of the step of applying the chlorine dioxide solution.

6. The method of claim 3, wherein the mulivalent acid is a trivalent acid.

7. The method of claim 6, wherein the trivalent acid is phosphoric acid.

8. The method of claim 2, wherein the acid is at least one of the group of citric acid, sulfuric acid, chlorhidric acid, sulfamic acid, oxalic acid and acetic acid.

9. The method of claim 2, wherein approximately 324 ml of the sodium chlorite solution at 1.5 to 2.5% concentration by weight and approximately 324 ml of the acid solution at 1.0 to 5.0% concentration by weight are used for each acre of growing plants.

10. The method of claim 1, wherein the application of chlorine dioxide provides approximately between 0.0055 and 0.011 pounds per acre on at least one of growing plants, soil, and a plant substrate.

11. The method of claim 1 wherein the step of applying comprises spray treatment.

12. The method of claim 1 wherein the step of applying comprises soil treatment.

13. A composition for elimination of at least one of bacteria, fungi, virus, and mold in growing plants, and the stimulation of plant health, vitality, and productivity comprising:
chlorine dioxide and phosphorus in solution.

14. The composition of claim 13, wherein the chlorine dioxide and phosphorus solution concentration is approximately that created with:
an amount of sodium chlorite in aqueous solution having a concentration found in approximately 0.63 pounds of NaClO₂ per gallon of water; and
an equal amount by weight of approximately 1-5% concentration acid in aqueous solution; and
approximately 211 gallons of water.

15. The composition of claim 14, wherein the acid is at least one of the group of phosphonic, or phosphorus acid solutions or an acid solution containing phosphorus.
